(19) United States
(12) Patent Application Publication
(10) Pub. No.: US 2023/0246969 A1
(43) Pub. Date: Aug. 3, 2023

(54) BOTTLENECK STRUCTURES FOR CAPACITY PLANNING

(71) Applicant: Reservoir Labs, Inc., San Diego, CA (US)

(72) Inventors: Jordi ROS GIRALT, Vilafranca del Penedes (ES); Noah Isaac AMSEL, New York, NY (US)

(21) Appl. No.: 17/988,687

(22) Filed: Nov. 16, 2022

Related U.S. Application Data
(63) Continuation-in-part of application No. 17/373,261, filed on Jul. 12, 2021, now Pat. No. 11,522,807.
(60) Provisional application No. 63/076,629, filed on Sep. 10, 2020.
(60) Provisional application No. 63/280,129, filed on Nov. 16, 2021.

(51) Int. Cl. H04L 47/127; H04L 45/036; H04L 45/302; H04L 47/762; H04L 47/70

(52) U.S. Cl. CPC H04L 47/127; H04L 45/036; H04L 45/3065; H04L 47/762; H04L 47/822

(57) ABSTRACT

A processor-implemented method includes receiving a network topology describing a network. The method also includes receiving a set of traffic patterns for the network, and a set of network upgrade plans for the network. The method obtains a set of performance parameters from a list of bottleneck structures based on the set of traffic patterns and the network topology, for each upgrade plan. The method then selects a preferred network upgrade plan from the set of network upgrade plans based on the performance parameters.

### CROSS-REFERENCE TO RELATED APPLICATIONS

The present application is a continuation-in-part of U.S. Pat. Application No. 17/373,261, titled “Computationally Efficient Analysis and Management of Systems Modeled as Networks,” filed on Jul. 12, 2021, which claims the benefit of U.S. Provisional Patent Application No. 63/076,629, titled “Computing Bottleneck Structures at Scale for High-Precision Network Performance Analysis,” filed on Sep. 10, 2020, and the present application also claims the benefit of U.S. Provisional Pat. Application No. 63/280,129, titled “Using Bottleneck Structures for Efficient Data-Driven Capacity Planning,” filed on Nov. 16, 2021, the disclosures of which are incorporated by reference in their entireties.

### GOVERNMENT LICENSE RIGHTS

This invention was made with government support under Contract No. DE- SC0019523 awarded by the U.S. Department of Energy (DoE). The government has certain rights in the invention.

### FIELD OF THE DISCLOSURE

This disclosure generally relates to network planning, and more specifically bottleneck structures for efficient data-driven capacity planning.

### BACKGROUND

Congestion control is an important component of high-performance data networks, that has been intensely researched for decades. Since 1988, when Van Jacobson proposed the first congestion control algorithm, the analysis of bottlenecks in data networks has been studied. Van Jacobson’s process is believed to have saved the Internet from congestion collapse. One of the main goals of congestion control is to distribute the limited bandwidth of each link in the network among the various data flows that need to traverse it. Congestion control processes have a dual mandate of maximizing network utilization while also ensuring fairness among competing flows. The conventional view of this problem assumes that the performance of a flow is solely determined by its bottleneck link-that is, the link in its path that allocates the least bandwidth to it.

More specifically, much of the research during the past three decades has been premised on the notion that a flow’s performance is uniquely determined by the capacity of its bottleneck and the communication round trip time of its path. This view has led to dozens of congestion-control processes based on characterizing (whether implicitly or explicitly) the performance of each flow’s bottleneck. Well-known works in this vein include bottleneck bandwidth and round-trip propagation time (BBR), Cubic, and Reno. These standard congestion control processes in the TCP protocol generally operate at the level of individual flows, the transmission rates of which are set separately by each sender. While these processes have been crucial to the success of large-scale communication networks like the Internet, they continue to treat bottlenecks as independent elements and do not consider their interactions or dynamic nature.

One line of research has taken a more global view by modeling networks as instances of multi-commodity flow problems. The classical formulation of these problems is altered to include a notion of fairness between competing flows. This approach has been applied to routing and load balancing problems under the assumption of multi-path routing; processes typically involve iteratively solving a series linear programs and adjusting the constraints. This approach has a high computational complexity that makes scaling difficult, despite algorithmic tricks to mitigate the cost. Moreover, this framework is somewhat brittle; it obscures the roles played by individual elements in determining network behavior, lacking, for example, an equivalent notion to link and flow derivatives.

Wide Area Networks are regularly upgraded to keep up with growing demand. There are several types of upgrade operations, for example, increasing the capacity of an optical link by lighting new wavelengths. Each of these operations has a cost in equipment and labor, and each has the potential to increase the performance of the network. It would be desirable to be able to efficiently choose one or more network upgrades that achieve a maximum expected increase in performance within a fixed budget.

### SUMMARY

Treating bottlenecks as independent elements and not considering their interactions or dynamic nature makes it difficult to consider the network (any complex system, in general) as a whole, since it hides the complex ripple effects that changes in one part of the network (or system) can exert on the other parts. The Theory of Bottleneck Structures, was introduced in U.S. Pat. Application No. 17/181,862, titled “Network Analysis and Management Based on a Quantitative Theory of Bottleneck Structures,” filed on Feb. 22, 2021 (the “’862 Application”) and also in U.S. Pat. Application No. 16/580,718, titled “Systems and Methods for Quality of Service (Qos) Based Management of Bottlenecks and Flows in Networks,” filed on Sep. 24, 2019 (the “’718 Application”). Each of the ’862 Application and the ’718 Application is incorporated herein by reference in its entirety, provide a deeper understanding of congestion controlled networks. They describe how the performance of each link and data flow depends on that of the others, forming a latent dependency structure that can be modeled as a directed graph. Armed with this model, network operators can make accurate, quantitative predictions about network behavior, including how local changes like link upgrades, traffic shaping, or flow routing will propagate, interact with one another, and affect the performance of the network as a whole. The Theory of Bottleneck Structures can be used to reason about a large variety of network optimization problems, including traffic engineering, congestion control, routing, capacity planning, network design, and resiliency analysis.

One of the goals of the discussion below is to demonstrate that the insights of the Theory of Bottleneck Structures can be applied at scale to production networks. Previous work introduced a software system that implemented the two core operations of constructing the bottleneck structure graph and computing derivatives of network performance with respect to parameters like link capacities and traffic shapers. However, this system was tested on relatively small networks, and its performance was not benchmarked. In this work, we demonstrate a new high-performance software package designed to scale these two core operations to production-size networks. Using real production NetFlow logs from ESnet-the Department of Energy’s high-performance network connecting the US National Laboratory system-we performed extensive benchmarks to compare the two packages and characterize their scalability. We confirm that, with the right implementation, bottleneck structures can be used to analyze large networks in practice, thus unlocking a powerful new framework to understand performance in production environments.

Accordingly, in one aspect a method is provided for determining a change in a first system parameter (e.g., flow throughput, storage or processing latency, etc.) in response to an incremental change in a second system parameter (e.g., available link capacity, processing capacity, etc. The method includes performing by a processor the step of generating a bottleneck structure representing the system. The bottleneck structure includes several elements, where each element represents a respective system resource or a respective user of one or more system resources. The bottleneck structure has several levels. Respective elements at successive levels indicate increasing resource utilization, resource availability, or resource requirement. For example, the flow rates or processing rates at an upper level are typically less than the flow or processing rates at a lower level.

The method also includes receiving an element identifier identifying one of the several elements, and selecting elements that are directly impacted (e.g., those that may be represented as immediate successors or children of the identified element, if the bottleneck structure is a graph), by a change in a parameter associated with the identified element. In addition, the method includes determining, for each selected element, a respective initial incremental change in a respective associated parameter. The method further includes recursively propagating the respective initial incremental changes through the bottleneck structure, and deriving a change in the first system parameter by accumulating respective changes in respective parameters associated with elements of a specified type of the bottleneck structure.

In some aspects, the several elements include one or more resource elements, where a resource element represents a resource parameter of a corresponding system resource. Additionally or in the alternative, the several elements may include one or more user elements, where a user element represents a utilization parameter of a corresponding user (also referred to as demand source) of the system. The parameter associated with the identified element may include resource utilization, resource availability, or resource requirement. Likewise, the parameter associated with one of the selected elements may include resource utilization, resource availability, or resource requirement.

The identified element may include a resource element or a user element, and the directly impacted elements may also include resource elements or a user elements. In some aspects, the several elements include one or more resource elements of a first type, where a resource element of the first type represents a resource parameter of a corresponding system resource of the first type. Additionally, the several elements may include one or more resource elements of a second type, where a resource element of the second type represents a resource parameter of a corresponding system resource of the second type.

In some aspects, the several elements include one or more link elements corresponding, respectively, to one or more links in a network. The network may be a data network, or a network representation of a system. The several elements also include one or more flow elements corresponding, respectively, to one or more network flows. Flow elements at a first level may correspond to flows having smaller flow rates than rates of flows corresponding to flow elements at a second level. The element identifier identifies a link element, and the first system parameter includes total network flow throughput.

In some aspects, the step of recursively propagating includes storing in a heap structure identifiers of one or more of the several elements. The heap structure may include two-key heap structure, where: a first key represents a base value of a parameter associated with an element of the bottleneck structure, and a second key represents a increment to the base value. The increment can be positive, zero, or negative. Recursively propagating the respective initial incremental changes through the bottleneck structure may include propagating a first initial incremental change through the bottleneck structure at a first processor, and propagating, in parallel, a second initial incremental change through the bottleneck structure at a second processor. In some aspects, the step of recursively propagating the respective initial incremental changes through the bottleneck structure may include applying a propagation rule corresponding to a type of the selected elements.

In another aspect, a computing apparatus is provided for determining a change in a first system parameter of a system in response to an incremental change in a second system parameter. The system includes a first processor and a first memory in electrical communication with the first processor. The first memory includes instructions that, when executed by a processing unit that includes one or more computing units, where one of such computing units may include the first processor or a second processor, and where the processing unit is in electronic communication with a memory module that includes the first memory or a second memory, program the processing unit to: generate a bottleneck structure representing the system.

The bottleneck structure includes several elements, where each element represents a respective system resource or a respective user of one or more system resources. The bottleneck structure has several levels. Respective elements at successive levels indicate increasing resource utilization, resource availability, or resource requirement. For example, the flow rates or processing rates at an upper level are typically less than the flow or processing rates at a lower level.

In addition, the instructions program the processing unit to receive an element identifier identifying one of the several elements, and to select elements that are directly impacted (e.g., those that may be represented as immediate successors or children of the identified element, if the bottleneck structure is a graph), by a change in a parameter associated with the identified element. The instructions also program the processing unit to determine, for each selected element, a respective initial incremental change in a respective associated parameter. Moreover, the instructions program the processing unit to propagate recursively the respective initial incremental changes through the bottleneck structure, and to derive a change in the first system parameter by accumulating respective changes in respective parameters associated with elements of a specified type of the bottleneck structure.

In various aspects, the instructions can program the processing unit to perform one or more of the method steps described above.

According to aspects of the present disclosure, a processor-implemented method includes receiving a network topology describing a network; receiving a set of traffic patterns for the network; and receiving a set of network upgrade plans for the network. The method also includes obtaining a set of performance parameters based on the set of traffic patterns and the network topology, for each upgrade plan; and selecting a preferred network upgrade plan from the set of network upgrade plans based on the performance parameters.

Other aspects of the present disclosure are directed to an apparatus. The apparatus has a memory and one or more processors coupled to the memory. The processor(s) is configured to receive a network topology describing a network. The processor(s) is also configured to receive a set of traffic patterns for the network. The processor(s) is further configured to receive a set of network upgrade plans for the network. The processor(s) is also configured to obtain a set of performance parameters from a list of bottleneck structures based on the set of traffic patterns and the network topology, for each upgrade plan. The processor(s) is configured to select a preferred network upgrade plan from the set of network upgrade plans based on the performance parameters.

Other aspects of the present disclosure are directed to an apparatus. The apparatus includes means for receiving a network topology describing a network. The apparatus also includes means for receiving a set of traffic patterns for the network. The apparatus further includes means for receiving a set of network upgrade plans for the network. The apparatus also includes means for obtaining a set of performance parameters from a list of bottleneck structures based on the set of traffic patterns and the network topology, for each upgrade plan. The apparatus includes means for selecting a preferred network upgrade plan from the set of network upgrade plans based on the performance parameters.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The present disclosure will become more apparent in view of the attached drawings and accompanying detailed description. The aspects depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the invention. In the drawings:

FIG. 1 depicts an example network configuration.

FIG. 2 is a bottleneck structure of the network shown in FIG. 1, according to one aspect.

FIGS. 3 and 4 show processes for generating a bottleneck structure for a network/system, according to some aspects.

FIG. 5 shows a process for computing a derivative, or a change resulting in one system parameter due to a change in another system parameter, where the computation relies on regeneration of the bottleneck structure, according to some aspects.

FIGS. 6A and 6B show computationally efficient processes for computing a derivative, or a change resulting in one system parameter due to a change in another system parameter, where the computation relies on only one generation of the bottleneck structure, and avoids regeneration, according to some aspects.

FIG. 7 depicts the topology and the ES Net network used in various experiments.

FIG. 8 shows the time taken to compute the bottleneck structure of the network shown in FIG. 7, according to two different aspects.

FIGS. 9A and 9B show the asymptotic run times of an aspect of the FastComputeBS process in relation to the network size and number of flows, respectively.

FIG. 10 shows memory usage of two different aspects in generating the bottleneck structure shown in FIG. 8.

FIG. 11 shows the space complexity or the asymptotic memory usage of an aspect of the FastComputeBS process in relation to the network size.

FIG. 12 shows the time taken to compute a derivative, a change in throughput in response to an infinitesimal change in the capacity of a link, for the network shown in FIG. 7, according to three different aspects.

FIGS. 13A-13F plot the runtimes of the three processes, according to three respective aspects, against the size of the given link’s region of influence and against the total number of flows in the network.

FIG. 14 shows the speed-up in an aspect of ForwardGrad compared to an aspect of BruteGrad^(++), in relation to a link’s region of influence.

FIG. 15 shows memory usage of three different aspects in computing a derivative, a change in throughput in response to an infinitesimal change in the capacity of a link, for the network shown in FIG. 7.

FIGS. 16A and 16B show the asymptotic behavior of an aspect of ForwardGrad′ memory usage in computing the derivative described in connection with FIG. 15.

FIG. 17 schematically depicts a heterogeneous computing system that can be analyzed using various aspects of processes for computing the bottleneck structure and derivatives of a system.

FIG. 18 is a diagram illustrating a capacity planning process showing inputs, computations, and an output, in accordance with some aspects of the disclosure.

FIG. 19 is a flow diagram illustrating an example process performed, for example, by a user equipment (UE), in accordance with various aspects of the present disclosure.

### DETAILED DESCRIPTION

The existence of complex interactions among bottlenecks has not gone completely unnoticed in the research community. For instance, it has been recognized that the situation may become more complicated as the number of links increases because, as flows are added or terminated, the fair-share rates of links generally change. Accordingly, the bottleneck links for flows may change, which may in turn affect other bottleneck links, and so on, potentially propagating through all the links in a network.

No solution to this problem was offered, however, until we first did in the ’862 Application, which is incorporated by reference in its entirety. This work introduced the concept of latent bottleneck structures and used a directed graph to model them. It also introduced the first process to compute the bottleneck structure, which appears in the discussion below as ComputeBS. We describe herein techniques for generating such bottleneck structures in a computationally efficient manner, and also using them for system analysis in an efficient manner, taking advantage of the ordered nature of the bottleneck structures, so that these structures can be used to analyze and optimize real-life systems.

We provided a software package for computing bottleneck structures and using them to analyze networks (systems, in general). Python implementations of the ComputeBS and BruteGrad processes were provided, along with functionality for reading sFlow logs and performing simulations. We use their package as a baseline in the discussion below. Various implementations of the FastGrad process can improve computing efficiency by minimizing processor load and/or required memory when used to analyze large networks and systems.

A benchmark of the techniques described below to compute bottleneck structures is also provided, demonstrating that, when efficiently implemented, these techniques can scale to support the size of real production networks (systems, in general). This result confirms the practical usefulness of bottleneck structures as a framework to help network operators understand and improve performance with high-precision.

The discussion below is organized as follows. In Section 2, we provide a brief introduction to bottleneck structures and summarize the core processes that are the subject of the presented benchmarks. Section 3 describes the data set and reports the benchmarks for the computation of bottleneck structures (Section 3.2) and link gradients (Section 3.3). Section 4 discusses integration of the benchmarked processes in real production networks and systems. Application of techniques described herein to complex systems is described in Section 5. Section 6 presents conclusions.

### 2 Theoretical Background and Processes

### 2.1 Introduction to Bottleneck Structures

While describing the mathematics of bottleneck structures is not the focus of this paper, this section provides an example that will give the reader some intuition for the meaning and analytical capabilities of a bottleneck structure.

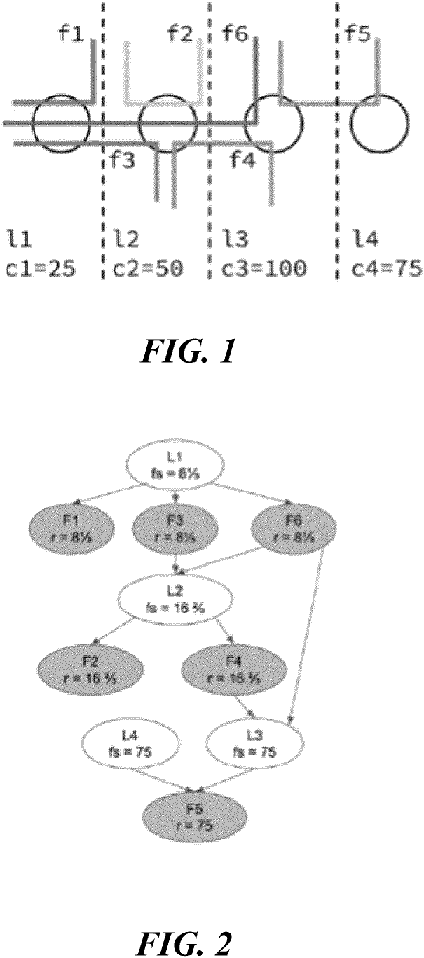

Example 1: Consider a network shown in FIG. 1, having four links {1_1,1_2,1_3,1_4} in which there are six active data flows {f_1, . . .,f_6}. The capacity of each link (c_1,...,c_4) and the route of each flow is shown in FIG. 1. (We do not consider the network’s topology, just the set of links in each flow’s route.) The resulting bottleneck structure of this example network is shown in FIG. 2. It is represented by a directed graph in which:

There exists one vertex for each flow (plotted in gray) and each link (plotted in white) of the network.

a) If flow f is bottlenecked at link 1, then there exists a directed edge from 1 to f.

If flow f traverses link 1 but is not bottlenecked by it, then there exists a directed edge from f to 1.

Intuitively, the bottleneck structure captures the influences that links and flows in the network exert on each other. Consider link 1. Three flows traverse it, and it has a capacity of 25. Thus, it allocates 25/3=8 ⅓ each to flows 1, 3, and 6. If the capacity of link 1 were to change, the rates of these three flows would change too. This relationship is reflected in the directed edges from node L1 to nodes F1, F3, and F6. Flow 3 also traverses link 2, but since link 2 has more bandwidth available than link 1, flow 3 is not bottlenecked there. The leftover bandwidth not used by flow 3 is picked up by other flows that use link 2—that is, by flow 2 and flow 4. So, if flow 3’s rate was to change, their rates would be affected too. This relationship is reflected in the directed paths F3 → L2 → F2 and F3 → L2 → F4. The reverse is not true. If L2′s rate was perturbed by a small amount, F3’s performance would not be affected, and indeed, no path from L2 to F3 exists. It has been proven that the performance of a flow f is influenced by the performance of another flow f if and only if there exists a directed path in the bottleneck structure graph from flow f’s bottleneck link to flow f.

The bottleneck structure allows us to easily visualize relationships between network elements. We can also quantify these relationships. Consider the congestion control process to be a function that takes the network conditions as input and assigns a transmission rate to each flow as output. A key insight stemming from the Theory of Bottleneck Structures is that many seemingly separate questions in network management can be unified under a single quantitative framework by studying the derivatives of this function. For example, letting c_1 be the capacity of link 1 and r_3 be the rate of flow 1, we have:

$$\left(\text{dr} \_ 3\right) / \left(\text{dc} \_ 1\right) = 1 / 3 ,$$

since each additional unit of capacity added at link 1 will be distributed evenly among the three flows which are bottlenecked there.

Derivatives with respect to flow rates can also be calculated; they represent, for example, the effect of traffic shaping a flow (that is, artificially reducing its rate) on the performance of another flow. In our experiments, we used the capacity c_1 of some link 1 as the independent variable. Derivatives can also be taken of any differentiable function of the rates, not just an individual rate like r_3. In the discussion below, we take the dependent variable to be the total throughput of the network, that is, the total rate of all its flows:

[image]

The derivative dT/(dc_1 ) quantifies how much the total throughput of the network would change if link 1 were given an infinitesimally higher capacity denoted δ.

It should be noted that the bandwidth allocation function is continuous everywhere, but not technically differentiable. In particular, it is piecewise linear. Thus, while the derivative does not exist at all points, we can study the directional derivative instead. Without loss of generality, we use ‘derivative’ to denote the derivative in the positive direction (δ>0 rather than δ<0 in line 2 of Process 3 discussed below.

The Theory of Bottleneck Structures is a somewhat idealized model of network behavior. In our example, we assumed that flow 3 would experience a rate of 8 ⅓, but in fact its rate will fluctuate as the congestion control process tries to calibrate it to network conditions, and due to other factors like latency. Nevertheless, our experiments showed that the theoretical flow rates predicted by the bottleneck structure model accurately match the actual transmission rates observed in networks that use popular congestion control processes like bottleneck bandwidth and round-trip propagation time (BBR) and Cubic. The Theory of Bottleneck Structures can also be extended; for example, a latent bottleneck structure still exists if a proportional fairness criterion is used to allocate rates instead of max-min fairness. The theory can also be applied to networks that use multipath routing by considering each route to be a separate flow, and optimizing the sum of their bandwidths instead of any individual bandwidth.

### 2.2 Applications of Bottleneck Structure Analysis

The scientific community has long relied on high-performance networks to store and analyze massive volumes of data. As the collection of scientific data continues to balloon, the importance of designing these networks intelligently and operating them at maximum efficiency will only increase. The analytical power of the Theory of Bottleneck Structures stems from its ability to capture the influences that bottlenecks and flows exert on each other and, in particular, to precisely quantify these influences. This ability can be applied to a wide range of networking problems. For example, taking derivatives of the form dT/(dc _1 ) is a natural way to study the problem of optimally upgrading the network.

The derivative of the total throughput with respect to the capacity of each link reveals which links should be upgraded to have the maximal impact on the overall performance of a network. Other questions in network design and capacity planning can be addressed using similar techniques. The Theory of Bottleneck Structures also sheds light on flow control problems like routing and traffic engineering. For example, if we want to increase the performance of a certain high priority flow and we know which flows are low priority, we can compute derivatives of the high priority flow’s rate to determine which of the low priority flows to traffic shape.

We can also make precise quantitative predictions of how much this intervention would increase performance. Applications also arise in other areas. For example, determining where a given flow is bottlenecked, who controls that bottleneck link, and how other traffic in the network affects the flow can help in monitoring and managing Service-Level Agreements (SLAs). Future work will describe such applications in greater detail, but few are feasible without high-performance processes and software for bottleneck structure analysis. One challenge of analyzing networks in practice is that network conditions change from second to second. The need to analyze networks in real time imposes even stricter performance requirements that previous work has failed to meet.

### 2.3 Constructing Bottleneck Structures

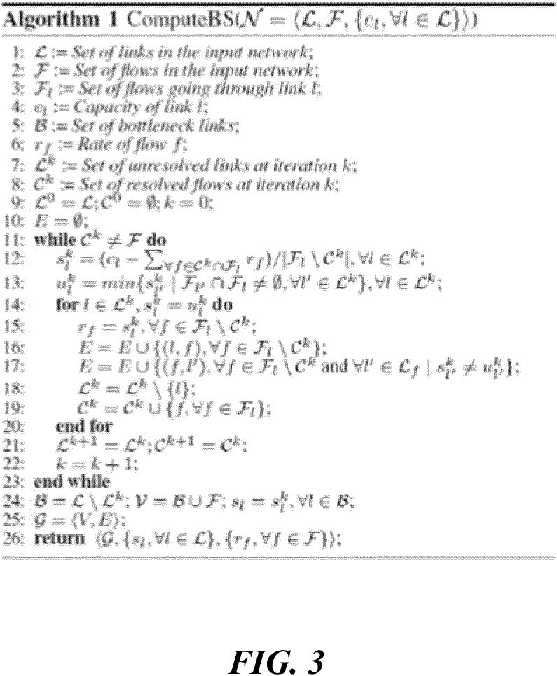

This section describes two processes for constructing bottleneck structures. The first corresponds to an improved version of the process proposed in the ’862 Application. The pseudocode is presented in FIG. 3, Process 1 called ComputeBS.

During each iteration of the main loop, a set of links are resolved, meaning the rates of all flows which traverse them are permanently fixed. This set of links is those whose “fair share value” s_1 at that iteration (line 12) is the smallest among all links with which they share a flow (line 13). The rates of all flows traversing link 1 which have not previously been fixed are set in line 15, and the link and its flows are marked as resolved (line 18 and 19). In addition, the proper directed edges are added to the bottleneck structure graph-from a links to flows which they bottleneck (line 16) and from flows to links that they traverse but that do not bottleneck them (line 17). The process returns the bottleneck structure G=(V,E), the link parameters {s_l,∀l∈L} and the predicted flow transmission rates {r_f,∀f∈F}.

This procedure includes logic to build the graph representation of the bottleneck structure. Its computational complexity is O(H•|L|^{∧}2+|L|•|F|), where L is the set of links, F is the set of flows and H is the maximum number of links traversed by any flow. Applying ComputeBS() to the network configuration shown in FIG. 1 can yield in the bottleneck structure shown in FIG. 2. It should be understood that a graph is only one type of data structure used to represent a bottleneck structure. Other suitable structures, that can express dependences between links and flows (resources and users, in general, as discussed below), may also be used. Examples of such structures include lists, linked lists, vectors, etc.

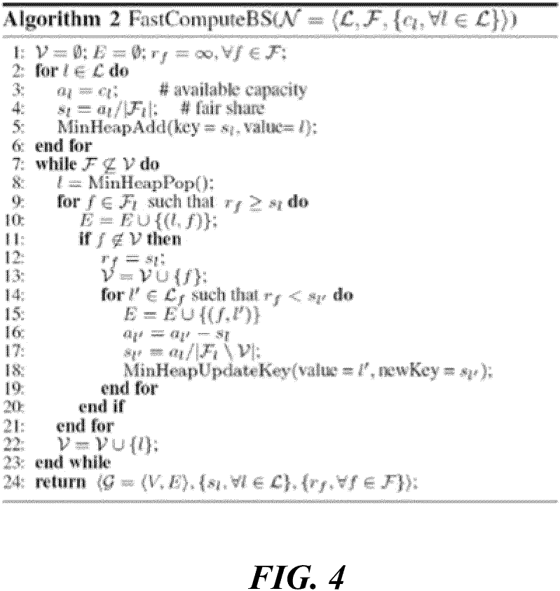

We next describe FastComputeBS (FIG. 4, Process 2), an improved process for computing bottleneck structures with an asymptotically faster run time and improved computational and memory efficiencies than ComputeBS. This process resolves links one-by-one, but unlike ComputeBS, it stores the links in a heap data structure sorted by the amount of bandwidth they can allocate to flows which traverse them. This allows the process to resolve links in the proper order without searching through the entire set of links at each iteration, effectively skipping the expensive min{} computation of Process 1 (line 13). FastComputeBS can reduce the asymptotic run time of computing the bottleneck structure to O(|E|•log|L|), where |E| is the number of edges in the bottleneck structure and |L| is the number of links. By definition, there is one edge for each pair of a flow and a link it traverses. Thus, the run time is quasilinear in the size of the input.

### 2.4 Computing Link Gradients

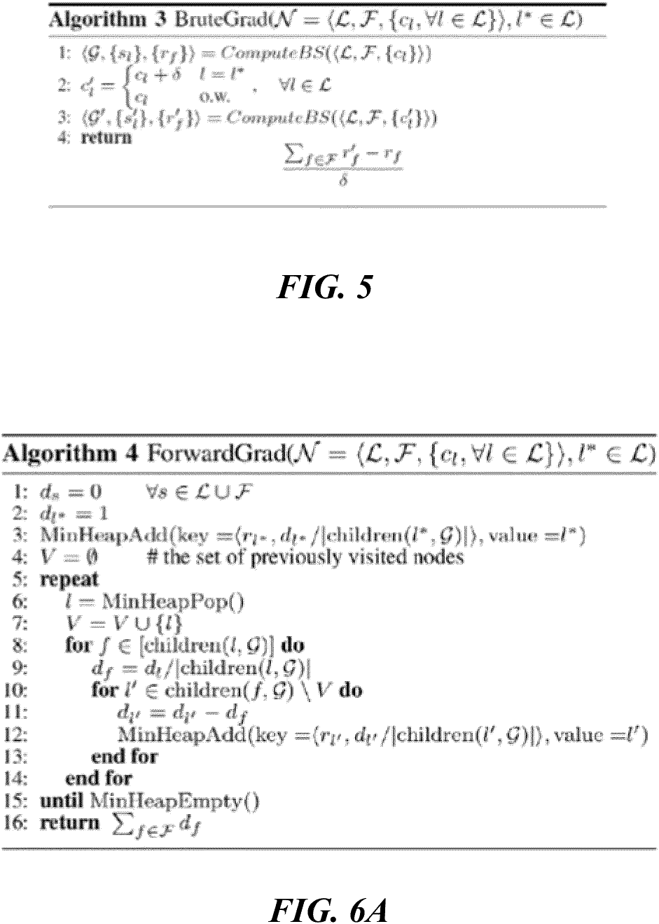

This section describes two processes for computing derivatives in a network (and, in general, in a system). Process 3 shown in FIG. 5 calculates the derivative ∂T/(∂c_(l^* ) ) by perturbing the capacity of a selected link l^* by an infinitesimally small constant δ. We then measure the change produced in the total throughput, and divide by δ to calculate the rate of change. Since the bandwidth allocation function is piecewise linear, this slope is exactly the derivative ∂T/(∂c_(l^* )). While this method is accurate, it requires recomputing the rates r_f′ from scratch, which is an expensive operation. Thus, we call this process BruteGrad. We can improve the process somewhat by replacing ComputeBS in lines 1 and 3 with FastComputeBS. We call this improved process BruteGrad^(++). While asymptotically faster than BruteGrad, it is still slow if many derivatives need to be computed.

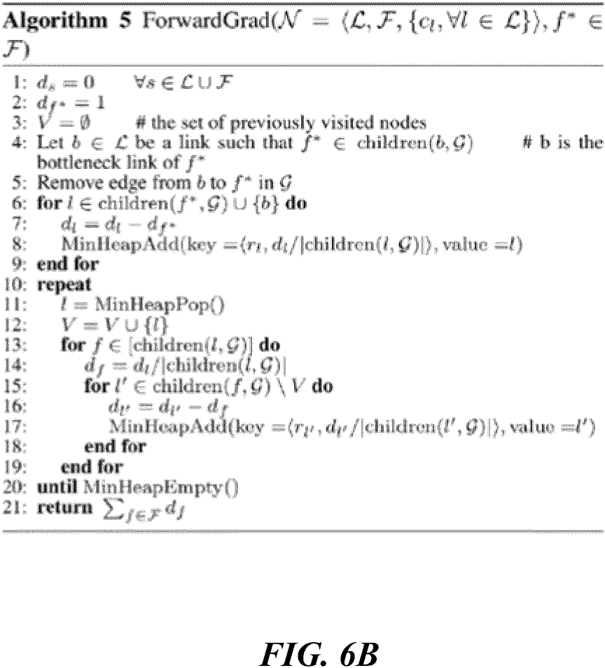

In contrast, Process 4 (ForwardGrad) shown in FIG. 6A uses the information captured in the bottleneck structure graph itself to speed up the computation of the derivative. A key insight for this process is that once the bottleneck structure has been computed, it can be reused to calculate different derivatives without the need to recompute the bottleneck structure for each derivative, as in the BruteGrad algorithm. The process is inspired by forward mode automatic differentiation (“Forward Prop”), a process for finding the derivative of a complicated expression that repeatedly applies the chain rule to larger and larger pieces of the expression. In our case, the bottleneck structure is related to a computation graph of a complicated expression, since a flow’s rate is determined by its bottleneck links, which in turn depend on its predecessors in the bottleneck structure.

But the relationship fails in two significant ways. First a flow’s rate can be affected by a change in its sibling’s rate that frees up extra bandwidth in their shared parent, even if the parent’s overall capacity stays the same. Second, a flow’s rate can fail to change when its parent link changes, if it also has another parent bottleneck link that does not change. Thus, while the process begins with the independent variable and propagates the derivatives forward according to the chain rule, it sometimes needs to backtrack in the graph to correct for these cases. Still, the process is a significant improvement on BruteGrad. It only requires visiting each link or flow at most once, and it only visits nodes which are affected by changes in 1^*. This means that ForwardGrad has a much lower asymptotic complexity than BruteGrad. In the extreme case, 1^* could have no descendants in the bottleneck structure, and the process will terminate immediately.

In Process 4,1^* represents a link for which the capacity may change infinitesimally (e.g., a small amount δ). When 1^* represents a link, in line 3, children[(1 ]^*,G) represents flows. In the iterations of line 6, 1 represents a link. Correspondingly, in the iterations of line 8, f represents a flow, and in the iterations of line 10, 1′ represents a link. In Process 5, shown in in FIG. 6B, the input received is f^*, representing a flow, where the actual or desired rate of the flow may change infinitesimally. In line 6 of Process 5, children[(f]^{∧}*,G) ∪{b} represents links that are utilized by the flow f^* but are not bottlenecks to the flow f^*. In the iterations of line 8, these links are added to the heap structure, and are accessed subsequently in line 11. The operations in lines 10 through 20 in Process 5 are similar to the operations in lines 5 through 15 in Process 4.

Since each node in the bottleneck structure is visited only once, the loop in line 8 and/or line 10 can be parallelized, to enhance performance of Process 4. For example, since the computations in lines 9 through 13 are performed for each child f, but using the same gradient graph G, the computations for one or more children may be performed using one processor and the computation for one or more other children may be performed in parallel, using a different processor. In one embodiment, |children (s,G)| distinct processors may be used, and the respective computations for all the children may be performed in parallel. In addition, or in the alternative, the computations in line 11 and 12 may be performed in parallel, in a similar manner has described for the computations in lines 9 through 13.

### 3 Benchmarks

### 3.1 Dataset and Experimental Environment

To ensure the benchmarks are performed on a realistic dataset, our team was given access to a set of anonymized NetFlow logs from ESnet. ESnet is a high-performance network built to support scientific research that provides services to more than 50 research sites, including the entire US National Laboratory system, its supercomputing facilities, and its major scientific instruments.

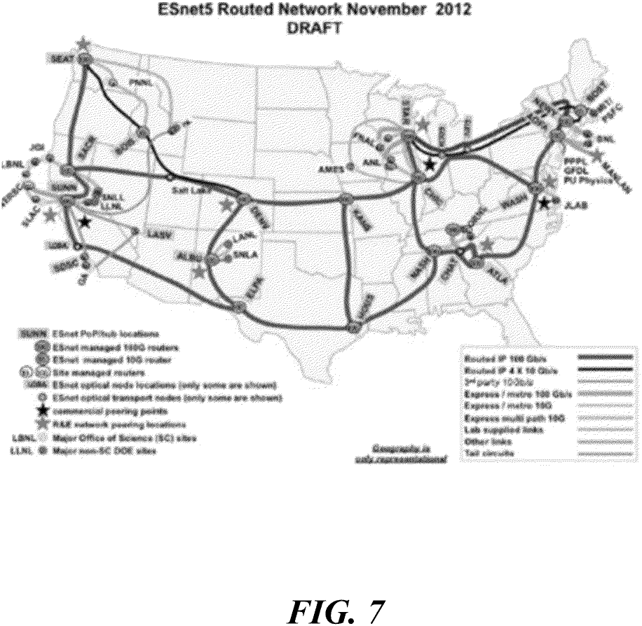

The dataset contains NetFlow logs from February 1st, 2013, through February 7th, 2013. At the time the logs were generated, ESnet had a total of 28 routers and 78 links distributed across the US. FIG. 7 depicts a view of the ESnet topology at the time the logs were captured. The dataset includes samples from all the routers, organized in intervals of 5 minutes, from 8am through 8pm, for a total of 1008 NetFlow logs for each router (or a total of 28224 logs across the network). The total data set is about 980 GB.

All tests were performed on an Intel Xeon E5-2683 v3 processor clocked at a rate of 2 GHz. The processor had 4 cores configured with hyperthreading disabled. L1, L2 and L3 caches had a size of 32 KB, 256 KB and 35840 KB, respectively, and the size of the RAM was 32 GB.

We benchmarked three software packages we developed for computing bottleneck structures. The first is a Python package that implements the ComputeBS process for computing bottleneck structures and the BruteGrad process for computing link gradients. The second is a C++ package equipped with a Python interface and functions to generate the bottleneck structure graph. It implements the FastComputeBS process for computing bottleneck structures and the BruteGrad^(++) process for calculating link gradients. The third package is also a C++ package similar to the second package, but implements the ForwardGrad processes for calculating link gradients.

### 3.2 Computing Bottleneck Structures at Scale

In this section, we benchmark and compare the two programs on the task of computing bottleneck structures. We expect the C++ package to be more efficient because it is written in a faster language and uses an asymptotically faster algorithm.

### 3.2.1 Runtime

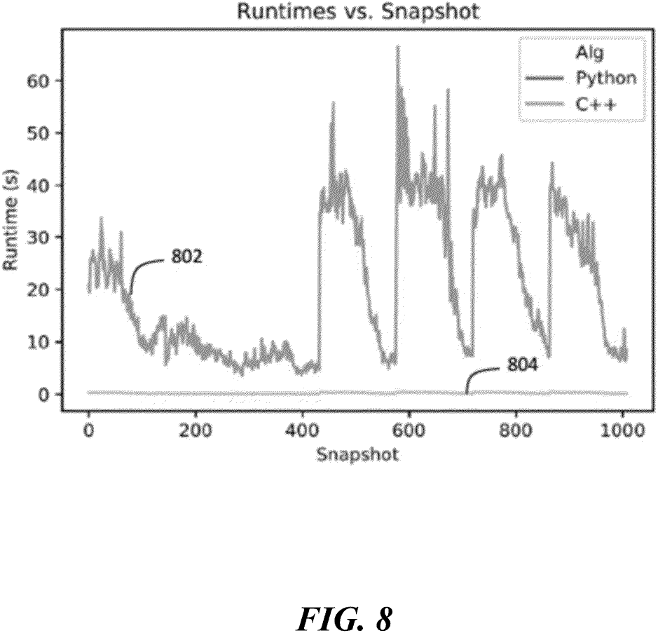

FIG. 8 plots the time taken by the first two package to compute the bottleneck structure of ESnet at each of the 1008 logging snapshots. The plot 802 shows the time taken by the Python package and the plot 804 shows the time taken by the C++ package. The seven separate days on which logs were collected are clearly distinguishable, corresponding to varying levels of traffic through the network (the gaps in our logs between 8 pm and 8 am each day are not represented in the plot). As expected, the C++ package is significantly faster than the Python package. The C++ package runs in 0.21 s on average, completing each in under 0.44 s, while the Python package averages 20.4 s and takes as long as 66.5 s. On average, the C++ package performs 87 times faster at this task.

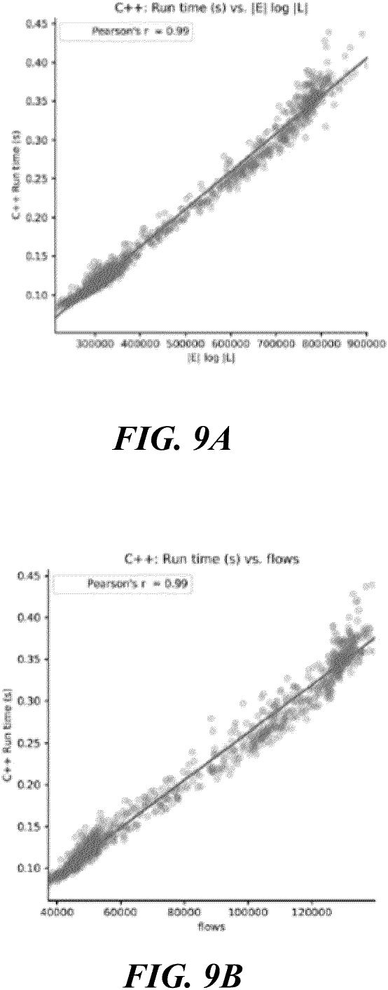

FIGS. 9A and 9B show the asymptotics of an aspect of the FastComputeBS algorithm. FIG. 9A plots the observed run time of the C++ package against the asymptotic bound |E|log|L|, showing very high correlation between the two. This indicates that the asymptotic bound tightly captures the true running time of the algorithm. FIG. 9B plots the runtime of each snapshot against the number of flows |F| present in the network at that time, also showing strong agreement. This is because, in our experiments, the number of links is the same across all snapshots, and since each flow traverses a small number of links, |E| is approximately linear in |F|.

### 3.2.2 Memory Usage

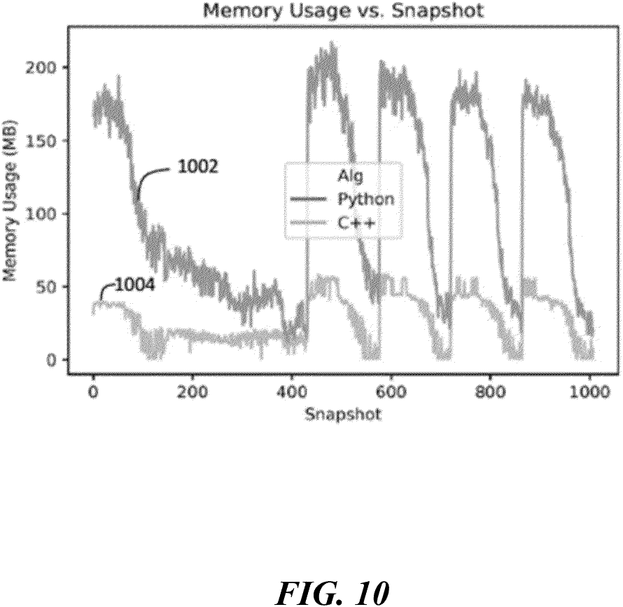

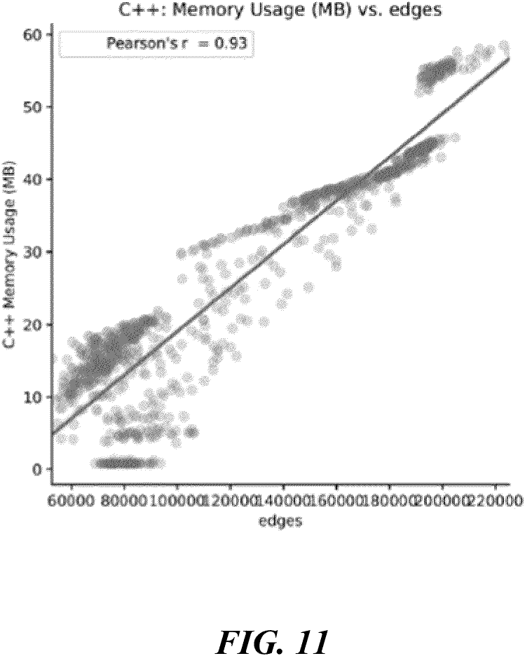

FIG. 10 plots the amount of memory used by the first two packages when computing the bottleneck structure of ESnet at each of the 1008 logging snapshots. In particular, plot 1002 shows instantaneous memory usage by the Python package and the plot 1004 shows the instantaneous memory usage by the C++ package. Both procedures build a directed graph with the same numbers of vertices and edges and, as such, the final memory consumptions by both packages are about the same. However, as FIG. 10 shows, the C++ package is far more efficient, using only 26.7 MB of memory on average. This represents a 4x median improvement over the Python package, because its instantaneous memory usage can exceed 200 MB. FIG. 11 demonstrates the space complexity of the FastComputeBS algorithm, showing that the amount of memory it uses is linear in the size of the input network.

### 3.3 Computing Link Gradients at Scale

In this section, we benchmark and compare the two programs’ functionality for computing link gradients. We consider three methods in all: the Python package’s BruteGrad, the C++ package’s BruteGrad^(++), and ForwardGrad, implemented and provided in the third (C++) package. This allows us to separate the effect of using a faster process from the effect of using a faster programming language. We consider one snapshot per hour over twelve hours. For each snapshot, we compute the derivative of the network’s total throughput with respect to each of its links using each of the three processes.

### 3.3.1 Runtime

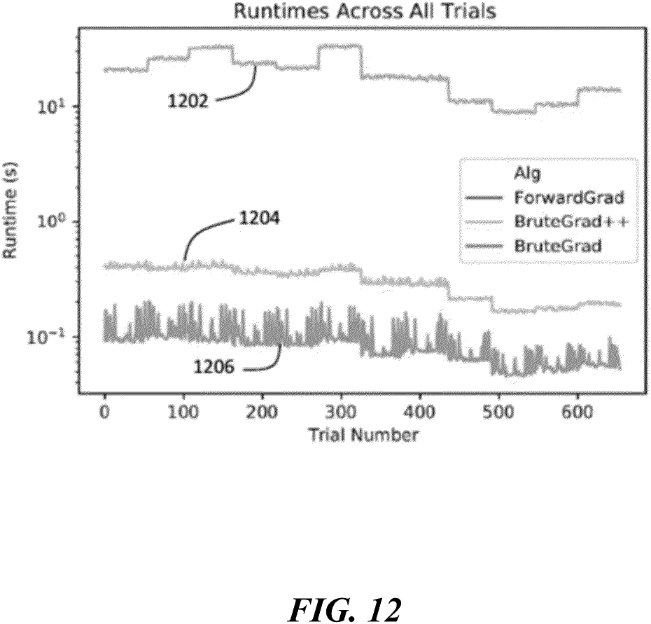

FIG. 12 shows the runtime of each process across all the links and snapshots on a log scale. The 12 different snapshots form discernible sections, since the state of the network remains constant throughout all trials within each snapshot. Plots 1202, 1204, and 1206 show the runtimes, respectively, of Python implementation of BruteGrad, C++ implementation of BruteGrad^(++), and C++ implementation of ForwardGrad. Derivatives, change in network throughput in response to an infinitesimal change in the capacity of a network link, were computed across 655 trials from 12 snapshots of the ESNet network.

Changing from the Python package’s BruteGrad to the C++ package’s BruteGrad^(++) reduces the average runtime from 19.9 s to 0.30 s, a 66-fold improvement. Notice that this is approximately the same improvement observed when moving from Python’s ComputeBS to C++’s FastComputeBS, since these processes are used as subroutines by BruteGrad and BruteGrad^(++). Changing to the C++ package’s ForwardGrad process further reduces the runtime to 0.09 s, a further 3.5-fold improvement. This level of performance makes it possible to compute a large number of derivatives in real time to respond to rapidly changing network conditions.

As discussed in Section 2.4, when ForwardGrad is used to compute a link derivative, the runtime is linear in the number of flows and links that are affected by the given link. This group, which we call the link’s “region of influence,” is simply the descendants of the link in the bottleneck structure graph. In contrast, the run times of the BruteGrad and BruteGrad^(++) processes depend on the size of the entire network, since they reconstruct the whole bottleneck structure. In ForwardGrad in rare cases, a single flow may be bottlenecked simultaneously at multiple links. In this case, the siblings of a link’s descendants may also be part of the region of influence, even if they are not themselves descendants of the given link. We observe no such cases in our experiments.

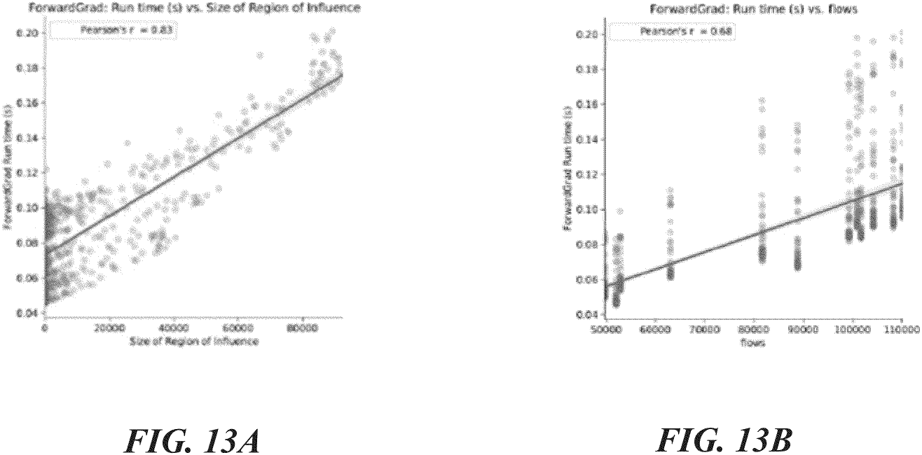

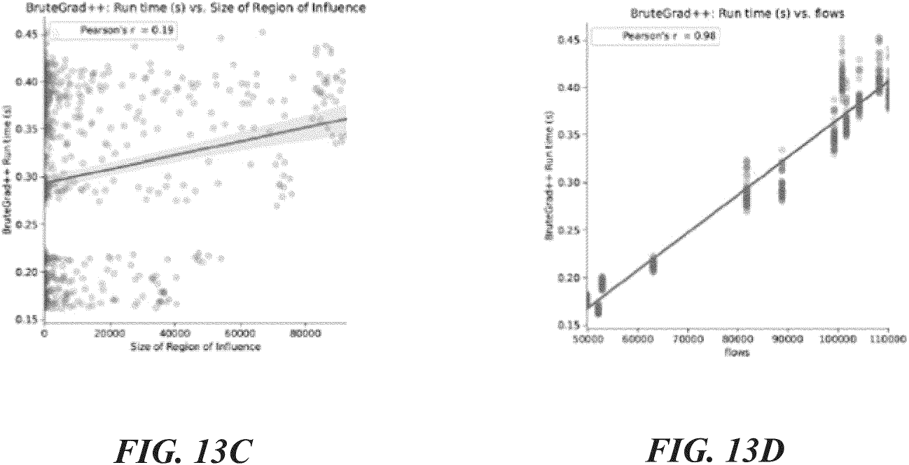

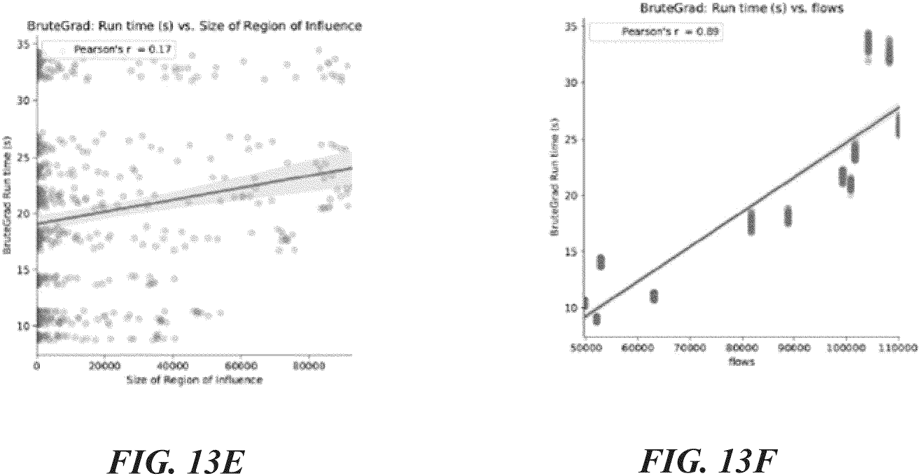

FIGS. 13A-13F plot the runtimes of the three processes, according to three respective aspects (the three software packages) against the size of the given link’s region of influence and against the total number of flows in the network. As expected, ForwardGrad is highly correlated with the former (FIG. 13A). It is also somewhat correlated with the number of flows (FIG. 13B), but only because networks with many flows also tend to have some links with many descendants. Even in these large networks however, the runtime falls under the line of best fit for most links. As FIGS. 13C and 13E show, the runtimes of BruteGrad^(++) and BruteGrad are not well explained by the size of the region of influence. Instead, like FastComputeBS and ComputeBS, as shown in FIGS. 13D and 13F, they are linearly dependent on the size of the network. ForwardGrad’s runtime is generally linear in the size of the region of influence, while BruteGrad and BruteGrad^(++) grow with the size of the network as a whole.

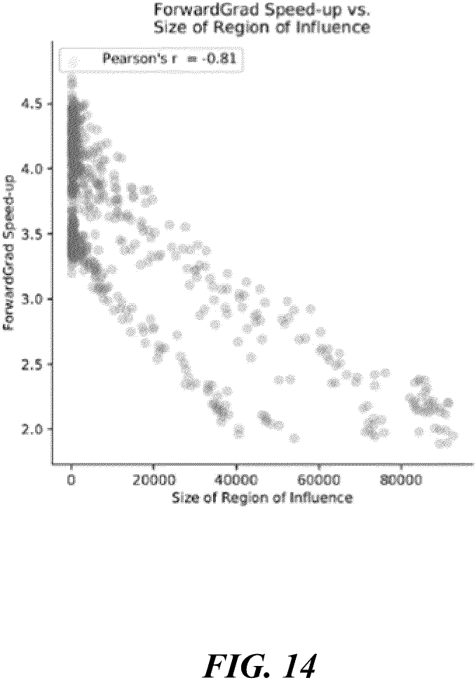

Given their time complexities, ForwardGrad is expected to exhibit a larger speed-up compared to BruteGrad^(++) in cases when the input link has a small region of influence. FIG. 14 plots this relationship, where the speed-up factor is obtained by replacing BruteGrad^(++) with ForwardGrad, and shows that the speed-up factor grows as the size of the region of influence approaches 0. This is because the size of region of influence shrinks in comparison to the network as a whole. Thus, the 3.5x average speed-up observed in our experiments would keep increasing as the processes are applied to larger and larger networks. In some aspects, a further speed-up can be attained by parallelized execution of ForwardGrad, as described above.

### 3.3.2 Memory Usage

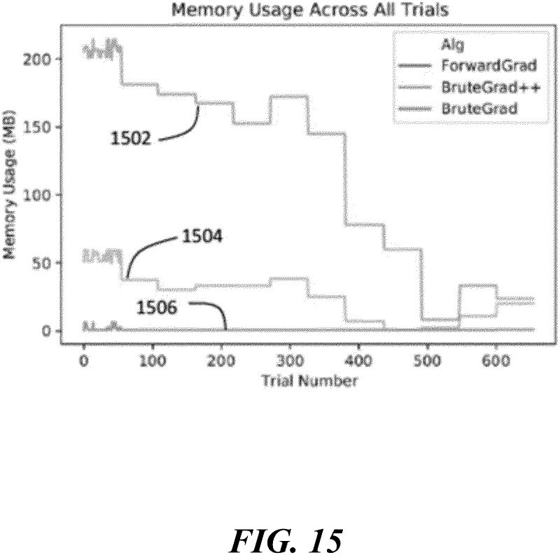

We profile the processes based on the amount of additional memory they need to compute each derivative given a pre-constructed bottleneck structure. In FIG. 15, traces 1502, 1504, and 1506 show, respectively, the instantaneous memory usages for a Python implementation of BruteGrad, a C++ implementation of BruteGrad^(++), and a C++ implementation of ForwardGrad. FIG. 15 shows that replacing the Python package’s BruteGrad with BruteGrad^(++) significantly reduces the memory usage—by a factor of 10 on average. Replacing BruteGrad^(++) with ForwardGrad has an even greater impact, reducing memory usage by a factor of 30 on average. Indeed, the average amount of additional memory used by ForwardGrad across all trials was just 850 KB, and the maximum was 6.4 MB. The steep decline in memory usage observed in the later trials reflects the fact that the number of flows in the network decreased precipitously at the end of the day.

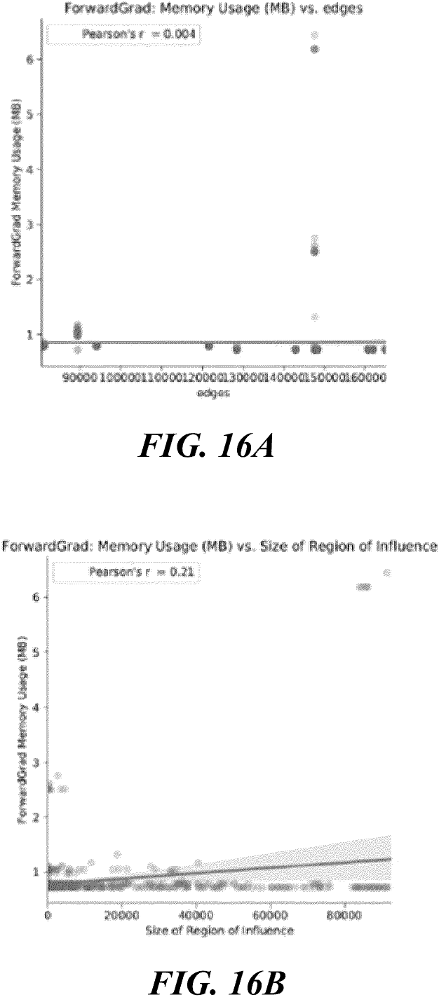

FIGS. 16A and 16B show the asymptotic behavior of an aspect (the third software package) ForwardGrad′ memory usage. Unlike the other processes, ForwardGrad does not use more memory as the network size increases, as FIG. 16A shows. In general, ForwardGrad’s memory usage does not grow with the size of the network. Technically, the space-complexity of ForwardGrad is linear in the size of the region of influence, as FIG. 16B shows, since ForwardGrad stores a derivative value for each element in that set. In our experiments however, we find that this dependence is so weak as to make the memory usage almost constant. As shown in FIG. 16B, if we only consider trials in the middle 99% by memory usage, to exclude outliers, then the correlation shrinks to 0.06. These experiments demonstrate that the ForwardGrad process is highly scalable and space-efficient.

### 5 Using FastComputeBS and ForwardGrad in Production Networks

The processes described herein were developed as part of the GradientGraph (G2) technology. G2 is a network optimization software package that leverages the analytical power of bottleneck structures to enable high-precision bottleneck and flow performance analysis. Network operators can use G2 to address a variety of network optimization problems, including traffic engineering, congestion control, routing, capacity planning, network design, and resiliency analysis, among others.

The G2 technology includes three layers: the core analytical layer, the user interface (northbound API) and the network interface (southbound API). Various aspects of the core analytical layer construct the bottleneck structure of the network (a system in general) under study using FastComputeBS and uses processes such as ForwardGrad (among others from the Theory of Bottleneck Structures) to analyze performance. Then, G2 provides network (system) operators with both online and offline recommendations on how to configure the network (system) to achieve better performance. Online recommendations address traffic engineering problems and include actions such as changing the route of a set of flows or traffic shaping certain flows to improve overall system performance. Offline recommendations address capacity planning and network design problems and include actions such as picking the optimal link to upgrade or identifying the most cost-effective allocation of link capacities (for instance, identifying optimal bandwidth tapering configurations in data center networks).

Various aspects of the user interface (northbound API) generally provide three mechanisms to interact with G2′s core analytical engine: a representational state transfer (REST) API to enable interactive and automated queries, a graphical user interface (GUI) that allows operators to visualize bottleneck structures and gradients, and a command line interface (CLI).

Various aspects of the network interface (southbound API) provide a set of plugins that allow for convenient integration of G2 into production networks. These plugins can read logs from flow monitoring protocols such as NetFlow, sFlow, or SNMP. The sets of links L and active flows in the network F can be easily reconstructed if such a monitoring protocol is enabled in all (or at least in several) of the routers and switches of the network. Otherwise, links and flows can be reconstructed with additional information extracted from SNMP (to learn the network topology) and from routing tables (to infer flow path information). The capacity parameters {c_l,∀l∈L} can be obtained from SNMP or static network topology files that production networks typically maintain. Some aspects of G2′s southbound API include plugins for all of these standard protocols to enable its integration with production networks.

### 5 Application to Complex Systems

While the discussion above is presented in the context of computer networks, this is only for the sake of convenience. In general, bottlenecks and bottleneck structures can exist in any system that can be modeled as a network, with multiple demand sources (also called users) looking to share resources through the network, and some objective of fairness. The demand sources correspond to “flows” in the discussion above. A bottleneck can be described as limiting the performance achieved by those demand sources in some manner due to limited availability of resources. The Theory of Bottleneck described herein and in the ’862 Application, and the ComputeBS, FastComputeBS, and ForwardGrad processes can be used to analyze and/or optimize such systems, as described below.

A system, in general, can be represented as a set of resources and users of those resources. Accordingly, a bottleneck structure is generally based on two types of elements: resource elements and user elements. The parameter(s) of the resource elements indicate the corresponding properties of resources of the system, such as link capacity, processing capacity (e.g., in million instructions per second (MIPS), floating-point operations per second (FLOPS), etc.), storage capacity, etc. The parameter(s) of the user elements indicate the corresponding properties of users of the system, i.e., these parameters generally quantify consumption of system resources (e.g., processing load of a task/computation, energy/power consumption, memory consumption, consumption of raw materials used in manufacturing, etc.

A resource element can be characterized as a negative user element, and vice versa. A change in a system can then be described using the propagation rules/equations of the resource and/or user elements. Specifically, the propagation rule/equation for a resource element 1 can be stated as: [image] where:
Δ_l is resource 1′s drift (a change in a resource parameter of a system resource represented by the resource element 1. For convenience, that resource may be referred to as resource 1);
P_l is a set of users using the resource 1. In some cases, P_l only includes the users that are not bottlenecked due to resource 1;
Δ_f is user f’s drift (a change in a utilization parameter of a system user represented by the user element f. For convenience, that user may be referred to as user f); and
S_l is a set of users bottlenecked by the resource 1, i.e., |S_1| is the number of users bottlenecked by the resource 1

The propagation rule/equation for a user element f can be stated as:

$$\begin{matrix}Δ \text{f} = \text{min} ⊤ \left(1 ∈ \left[\left(\text{P}\right)\right] \_ f\right) & \left[\left(Δ \_ 1\right)\right] ,\end{matrix}$$

where P_f is a set of resources due to which the user f is bottlenecked.

Typically, a system would have several different resources, operating in some relation to one another that can be represented by a network. For example, a hydro-electric power station may have electricity generators, transformers, automated valves and a network of conduits, and computers to control the operation of these, where the resources correspond to nodes of the network model, and the relations (flow from one to another) are edges of the network model. The operation of any of these would be impacted by factors such as scheduled maintenance of these components and unexpected faults in or failure of one of more components. Some factors that are beyond a system operator’s control can also impact the operation, e.g., required usage, of one or more system components. Examples of such factors include the precipitation and the water level in the reservoir from which the power station operates, average temperature in a region where the electricity is delivered, impacting the demand for electricity, availability of other generators on the electricity grid, etc.

Any one of these factors can create a bottleneck (or, conversely, insufficient utilization of a system resource). For example, an offline generator, transformer, or a conduit, can increase the load on one or more other generators. Uneven demands for electricity can cause an imbalance in the respective loads of one or more generators and/or transformers.

In the data networks described above, link capacity is a type of resource, where the different links are different resources, and the different network flows are the different users of these resources. In the hydro-electric power system, the different system components are the different resources, where the system includes different types of resources, as noted above. The electricity demands from different regions and/or consumers, or the electricity loads, are the different users of the system resources. A change in the availability and/or capacity of a resource and/or a change in a load can create a bottleneck. Moreover, the bottleneck can propagate through the system impacting other system resources and/or loads. As such, the techniques described herein can be used to analyze the bottlenecks and their propagation in the hydro-electric power system in an efficient manner, to serve the diverse demand sources in with some fairness criteria, and how that demand propagates through the components in relation to one another, as modeled in a network manner.

This analysis can also be used to manage system resources, for example, to adjust water flows, to bring generators online and to take them offline, etc., and/or to inform other grid operators the total and/or peaks loads that can be provisioned by the generation system, to optimize overall system objectives of performance, in terms of how the demand sources (users) are being served.

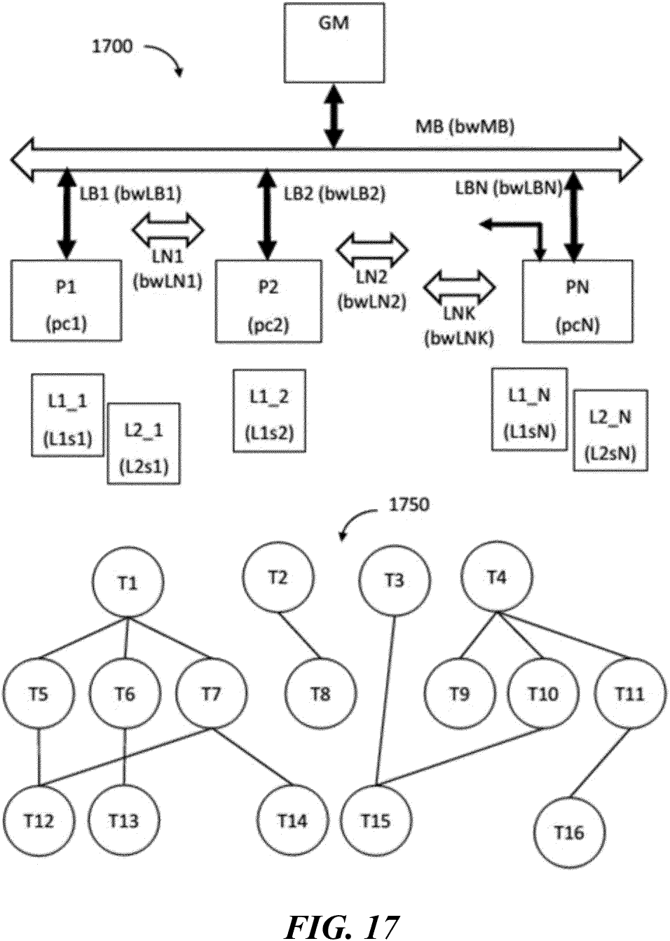

With reference to FIG. 17, another example of a system where the techniques described herein can be applied is a heterogeneous computing system 1700. Such a system, in general, includes heterogeneous processors P1, P2, ..., PN, i.e., several processors of several different types, such as graphics-processors, vector processors, general-purpose processors, multi-core processors, processors operating at different clock speeds, specialized processors such as math co-processors, signal-processing units, etc. One or more of these processors may include local cache memory. For example, processors P1 and PN include two levels of local cache L1 and L2. Processor P2 includes only one level of cache memory L1. These processors may communicate with each other via a main bus MB, where a particular processor is coupled to the main bus via a local bus LB1, LB2,..., LBN, etc. In addition, one or more processors may be locally connected via a local network such as LN1, LN2,..., LNK to one or more other processors. The local networks may connect the processors directly or via routers, but without relying on the main bus.

System 1700 thus includes several resources of different kinds such as processors, cache memory, local networks and buses, and a main bus. These resources have associated parameters. For example, for a processor a processing capacity may be expressed in MIPS. In some cases, a single processor may have different processing capacities depending on the operating frequency used, if frequency throttling is employed. Cache memory parameters may include cache size and latency. The parameters of a local network, a local bus, and the main bus may include bandwidth(s) and/or one or more communication latencies.

FIG. 17 also depicts a set of tasks 1750 that includes tasks T1 through T16 and that may be executed using the system 1700. It should be understood that the set of tasks 1750 is illustrative only and that, in general, any number of tasks (e.g., a few, tens, hundreds, thousands, or even more tasks) may be executed using a system such as the system 1700. As shown in the set of tasks 1750, there may be no dependence between certain tasks and, as such, they may be executed in parallel on different processors. Some tasks may be interdependent and, as such may be executed sequentially. In the system 1700, the various tasks are the users of the system resources. The tasks may also have associated parameters such as a maximum completion time, the latest start time, amount of data shared between one or more tasks, power/energy budget, etc.

In the system 1700, the value of a resource and/or user parameter and/or a change in the value of such a parameter can create a bottleneck that can propagate through the system, impacting other resources and users. Aspects of the ComputeBS, FastComputeBS, and ForwardGrad processes described herein can be used to analyze such bottlenecks and changes in resource or user parameters in an efficient manner. Moreover, this analysis can be used for designing and/or optimizing the system. For example, the set of tasks can be analyzed to determine the number of processors to be used, the types of processors to be used, the bandwidth of one or more networks to be provisioned, the sizes or one or more memories to be allocated for the computation of the tasks. These design choices can significantly improve the operation of the computing system 1700, e.g., in terms of processor and/or memory utilization, minimization of the required processing and/or memory capacity, minimizing energy and/or power consumption, and/or maximizing performance by minimizing the computation time(s). Conversely, the resource parameters may be treated as constraints to determine the achievable task parameters, such as, e.g., the worst-case completion time.

Other examples of systems where bottlenecks can occur and can be analyzed and the system and/or its use can be optimized include, but are not limited to: transportation systems for passengers and cargo; distribution systems such as those for oil, gas, and natural gas; domestic and industrial water supply and irrigation systems; storage systems, having different types of storage units such as cache memories, solid-state drives, hard disks, optical discs, etc., and communication links having different and/or adjustable bandwidths for interconnecting several storage units with one or more processing units; biological systems, where materials are consumed and transformed into other materials by one type of components, and the transformed materials are supplied to a another to another type of components, for consumption thereof and/or further transformation; etc.

Aspects of the processes described herein can apply not just to wired networks but also to networks that combine wired and wireless networks, where link capacities might include spatial and band constraints that limit the link capacity. Furthermore, in a system represented as a network, a link need not be a data link. Rather, the link may involve communication or movement of physical objects. What distinguishes the application of aspects of the processes described herein from general flow maximization, a well-known and long standing area of operations research, is when such systems have competing demand source (or users, tasks) that have to divide some resources of the system fairly, to some measure of fairness (e.g., max-min) while maximizing performance objectives, through a network model.

### 6 Bottleneck Structure Summary

In various aspects, the techniques described herein demonstrate practical applications of the Theory of Bottleneck Structures to production networks and other systems. In a series of experiments on the ESnet network, we show that our new software package far outperforms other techniques on the core operations of computing bottleneck structure graphs and computing link gradients. We also show that our FastComputeBS and ForwardGrad processes are highly scalable in both time and space complexity. FastCompute is shown to scale quasi-linearly with the size of the network (system, in general), and ForwardGrad is shown to scale linearly with the size of the region of influence.

These results demonstrate that bottleneck structure analysis is a practical tool for analyzing production networks and complex systems. The benchmarks indicate that our package can analyze networks that are even larger than ESnet and do so in real time, even as network conditions are changing rapidly. This is also true in the case of analysis of large systems, such as those described above. The efficiency of our core processes enables them to be used as subroutines in larger network/system optimization toolchains. The advances presented herein may unlock the potential of bottleneck structure analysis for myriad important applications.

In summary, the Theory of Bottleneck Structures is a recently-developed framework for studying the performance of data networks. It describes how local perturbations in one part of the network propagate and interact with others. This framework is a powerful analytical tool that allows network operators to make accurate predictions about network behavior and thereby optimize performance. We introduce the first software package capable of scaling bottleneck structure analysis to production-size networks and other systems. We benchmark our system using logs from ESnet, the Department of Energy’s high-performance data network that connects research institutions in the U.S. Using the previously published tool as a baseline, we demonstrate that our system achieves vastly improved performance, constructing the bottleneck structure graphs in 0.21 s and calculating link derivatives in 0.09 s on average.

We also study the asymptotic complexity of our core processes, demonstrating good scaling properties and strong agreement with theoretical bounds. These results indicate that our new software package can maintain its fast performance when applied to even larger networks. They also show that our software is efficient enough to analyze rapidly changing networks in real time. Overall, we demonstrate the feasibility of applying bottleneck structure analysis to solve practical problems in large, real-world data networks and in other systems.

### 7 Bottleneck Structures for Capacity Planning

Wide area networks are regularly upgraded to keep up with growing demand. There are several types of upgrade operations, for example, increasing the capacity of an optical link by lighting new wavelengths. Each of these operations has a cost in equipment and labor, and each has the potential to increase the performance of the network. The problem we consider is that of choosing one or more network upgrades that achieve the maximum expected increase in performance within a fixed budget. We address this problem by simulating the performance of the network after each possible upgrade on a large sample of traffic matrices. The large number of possible upgrades and the need to use a large sample to obtain accurate results would make this problem computationally infeasible with a naive algorithm. We leverage the incremental update process described above, to make this computation fast. Because each capacity upgrade operation involves only a single local change, it likely affects only a small subset of network elements, so the incremental update process yields massive speed ups. We combine this idea with local search heuristics and parallelization.

Intelligent capacity planning requires foreknowledge of how the network is used, specifically, the distribution of traffic patterns it will serve. Traditional approaches may optimize the network to serve a single given traffic matrix, which may correspond to an average case or worst case load, but a single traffic matrix is an inadequate model when planning over longer time periods. More sophisticated approaches may use a queuing model to better capture the balance between the mean traffic pattern and the tail of the distribution, but these models can be brittle and difficult to calibrate. We use a sampling approach because of its flexibility and fidelity to the observed behavior of the network. In the basic version of our method, samples are drawn from historical NetFlow data or other network logs. A single sample consists of measurements of the number of flows actively being transmitted between each pair of hosts, along with each flow’s path in the network and quality of service requirements (like minimum or maximum rate constraints). For example, in seeking to model the distribution of traffic patterns over the next year, a network operator could draw samples from the previous year’s log data in five minute intervals. In a more flexible version of our method, operators could adjust the samples to incorporate additional insights about how the traffic patterns will change in the future. For example, if a network operator predicts a 50% increase in demand between a particular pair of hosts over the next year, they could adjust each sample to include 50% more flows along that path. Furthermore, samples can be drawn more intelligently to meet specific operational goals. For example, if a network operator is particularly concerned with achieving optimal network performance during the workweek, they could draw most or all samples from the past year that occurred during the workweek, discarding most or all those from the weekend.

There are many possible kinds of network upgrades, including adding new physical links, lighting new wavelengths to increase the capacity of existing links, and creating IP (layer 3) logical links that overlay two or more existing links. From the perspective of our model, these fall into multiple categories:
1. Increasing the capacity of an existing link while keeping routing fixed. This is represented by the tuple (link, new capacity).
2. Adding a new link with a given capacity and rerouting some subset of traffic onto paths that traverse the new link. This is represented by the tuple (source node of new link, target node of new link, fraction of traffic to reroute).
3. Adding a new link with a given capacity by shifting that capacity from the links of an existing path, and rerouting some subset of traffic onto paths that traverse the new link. This is also represented by the tuple (source node of new link, target node of new link, fraction of traffic to reroute).

The cost of any of these operations depends on the specifics of the network. Rather than modeling cost explicitly, we allow network operators to specify a set of allowable operations. In the simplest case, we treat each operation as independent and consider them individually, returning the best upgrade. More generally, we can analyze groups of upgrades; for example, we could consider all possible tuples of links in the network to upgrade together. One notable feature of this approach is that the search space increases combinatorically. We consider scalable strategies for handling multiple upgrades below.

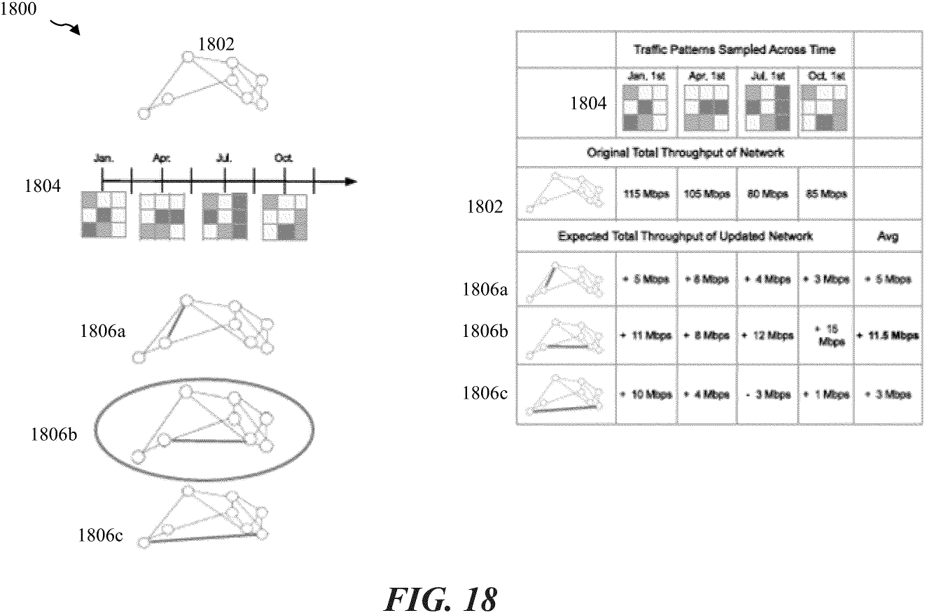

FIG. 18 is a diagram 1800 illustrating a capacity planning process in accordance with some aspects of the disclosure, showing inputs, computations, and an output, as described below.

Inputs:
A topology of a network 1802, that is, the hosts, links, and switches. Each link is labeled with its current capacity.
A list of traffic patterns 1804, where each traffic pattern 1804 is a list of flow groups, and each flow group is a tuple (path, number of flows, quality of service class)
A list of network upgrade plans 1806a, 1806b, 1806c, each of which is a list of single-link upgrades.
An evaluation function that maps a set of rates to a score. By default, this is total throughput (that is, the score is the sum of the input rates).

Output:
The network upgrade plan (1806b in this example) that maximizes the average value of the evaluation function over the input traffic patterns.

Based on the inputs, the capacity planning process initializes an empty list of bottleneck structures. For each traffic pattern, the process computes the bottleneck structure corresponding to (topology, traffic pattern) using the process described above, and appends the structure to the list.

The process then initializes a mapping from upgrade plans to total scores. For each upgrade plan, the two loops are executed (as seen in steps a and b below). The process then returns a preferred upgrade plan in the map with a maximum total score. It is noted that because the two loops are parallel, the process may be accelerated.
a. Insert (upgrade plan => 0) into the map
b. For each bottleneck structure
   i. Create a copy of the bottleneck structure
   ii. For each upgrade in the upgrade plan
      Apply the upgrade to the copy of the bottleneck structure using the incremental upgrade process described above.
   iii. Increment the value corresponding to this upgrade plan in the dictionary by the value of the evaluation function applied to the upgraded bottleneck structure

There are several ways to handle cases where the network operator wants to consider combinations of upgrades. For simplicity, we assume that the operator still provides a bag of allowable individual upgrades and a parameter k. Our goal is to select the set of up to k upgrades that yields the maximum performance. Thus, the parameter k captures the operator’s budget.

One approach is to use the process above, including each possible subsets of k upgrades as a separate upgrade plan. As previously stated, this approach may suffer from poor scaling. A second approach is to use a greedy heuristic. In the first stage, we run the capacity planning process with each upgrade plan containing a single upgrade. Having selected a best individual upgrade, we rerun the process where each upgrade plan contains the upgrade chosen in the first step plus a second upgrade. We iterate k times, greedily adding one new upgrade to our set in each iteration. A third approach is to use the Markov Chain Monte Carlo method. We begin with a randomly chosen set of k upgrades, and we allow transitions between upgrade plans that differ by exactly one upgrade. Given the bottleneck structure corresponding to a given traffic pattern and upgrade plan, we can still use the incremental update process to quickly find the scores of all of its “neighboring” upgrade plans.

The results of our method provide capacity planning recommendations to network operators. Using these recommendations, operators will be able to make informed decisions about buying new equipment, using this equipment to add or upgrade certain links in their networks, and rerouting traffic to take advantage of these upgrades. The improved network will then serve more traffic at faster speeds, with fewer packet drops and higher resilience to outages and link failures. Our accurate capacity planning recommendations will allow network operators to increase the efficiency of their networks, that is, the recommendations will improve, and may maximize, the quality of service experienced by the network’s users relative to the amount of money spent on building and maintaining the network.

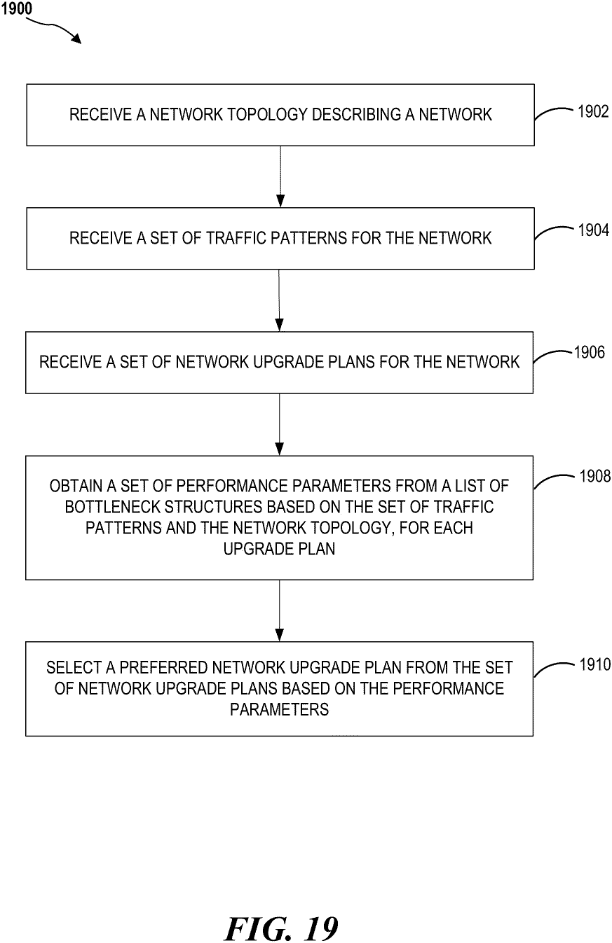

FIG. 19 is a flow diagram illustrating an example process 1900 for applying bottleneck structures for efficient data-driven capacity planning, in accordance with various aspects of the present disclosure.

As shown in FIG. 19, in some aspects, the process 1900 may include receiving a network topology describing a network (block 1902). In some aspects, the process 1900 may also include receiving a set of traffic patterns for the network (block 1904). In some aspects, the process 1900 may further include receiving a set of network upgrade plans for the network (block 1906). For example, the set of upgrade plans may be an increased capacity of an existing link, a new link with a new capacity, and/or a new link with a shifted capacity

In some aspects, the process 1900 may also include obtaining a set of performance parameters from a list of bottleneck structures based on the set of traffic patterns and the network topology, for each upgrade plan (block 1908). In some aspects, the process 1900 may also include selecting a preferred network upgrade plan from the set of network upgrade plans based on the performance parameters (block 1910). For example, the selecting may include applying an evaluation function to map the set of performance parameters to a score. In some aspects, the selecting further includes: initializing the list of bottleneck structures; for each traffic pattern in the list of traffic patterns, computing a bottleneck structure and adding the bottleneck structure to the list of bottleneck structures; for each upgrade plan of the set of upgrade plans and each bottleneck structure in the list of bottleneck structures, applying the upgrade plan to each bottleneck structure to obtain a new bottleneck structure and updating the performance parameters according to the new bottleneck structure; and outputting the preferred upgrade plan of the set of upgrade plans based on updated performance parameters.

### Example Aspects

Aspect 1: A processor-implemented method, comprising: receiving a network topology describing a network; receiving a set of traffic patterns for the network; receiving a set of network upgrade plans for the network; obtaining a set of performance parameters from a list of bottleneck structures based on the set of traffic patterns and the network topology, for each upgrade plan; and selecting a preferred network upgrade plan from the set of network upgrade plans based on the performance parameters.

Aspect 2: The processor-implemented method of Aspect 1, in which the selecting comprises applying an evaluation function to map the set of performance parameters to a score.

Aspect 3: The processor-implemented method of Aspect 1 or 2, in which the selecting further comprises: initializing the list of bottleneck structures; for each traffic pattern in the list of traffic patterns, computing a bottleneck structure and adding the bottleneck structure to the list of bottleneck structures; for each upgrade plan of the set of upgrade plans and each bottleneck structure in the list of bottleneck structures, applying the upgrade plan to each bottleneck structure to obtain a new bottleneck structure and updating the performance parameters according to the new bottleneck structure; and outputting the preferred upgrade plan of the set of upgrade plans based on updated performance parameters.

Aspect 4: The processor-implemented method of any of the preceding Aspects, in which the preferred network upgrade plan is a plan with a maximum total score.

Aspect 5: The processor-implemented method of any of the preceding Aspects, in which the maximum total score is based on values of the evaluation function over input traffic patterns.

Aspect 6: The processor-implemented method of any of the preceding Aspects, in which the set of upgrade plans comprises at least one of: an increased capacity of an existing link, a new link with a new capacity, and a new link with a shifted capacity.

Aspect 7: An apparatus, comprising: a memory; and at least one processor coupled to the memory, the at least one processor configured: to receive a network topology describing a network; to receive a set of traffic patterns for the network; to receive a set of network upgrade plans for the network; to obtain a set of performance parameters from a list of bottleneck structures based on the set of traffic patterns and the network topology, for each upgrade plan; and to select a preferred network upgrade plan from the set of network upgrade plans based on the performance parameters.

Aspect 8: The apparatus of Aspect 7, in which the at least one processor is further configured to apply an evaluation function to map the set of performance parameters to a score.

Aspect 9: The apparatus of Aspect 7 or 8, in which the at least one processor is further configured: to initialize the list of bottleneck structures; for each traffic pattern in the list of traffic patterns, to compute a bottleneck structure and add the bottleneck structure to the list of bottleneck structures; for each upgrade plan of the set of upgrade plans and each bottleneck structure in the list of bottleneck structures, to apply the upgrade plan to each bottleneck structure to obtain a new bottleneck structure and update the performance parameters according to the new bottleneck structure; and to output the preferred upgrade plan of the set of upgrade plans based on updated performance parameters.

Aspect 10: The apparatus of any of the Aspects 7-9, in which the preferred network upgrade plan is a plan with a maximum total score.

Aspect 11: The apparatus of any of the Aspects 7-10, in which the maximum total score is based on values of the evaluation function over input traffic patterns.

Aspect 12: The apparatus of any of the Aspects 7-11, in which the set of upgrade plans comprises at least one of: an increased capacity of an existing link, a new link with a new capacity, and a new link with a shifted capacity.

Aspect 13: An apparatus, comprising: means for receiving a network topology describing a network; means for receiving a set of traffic patterns for the network; means for receiving a set of network upgrade plans for the network; means for obtaining a set of performance parameters from a list of bottleneck structures based on the set of traffic patterns and the network topology, for each upgrade plan; and means for selecting a preferred network upgrade plan from the set of network upgrade plans based on the performance parameters.

Aspect 14: The apparatus of Aspect 13, in which the means for selecting further comprises means for applying an evaluation function to map the set of performance parameters to a score.

Aspect 15: The apparatus of Aspect 13 or 14, further comprising: means for initializing the list of bottleneck structures; for each traffic pattern in the list of traffic patterns, means for computing a bottleneck structure and adding the bottleneck structure to the list of bottleneck structures; for each upgrade plan of the set of upgrade plans and each bottleneck structure in the list of bottleneck structures, means for applying the upgrade plan to each bottleneck structure to obtain a new bottleneck structure and updating the performance parameters according to the new bottleneck structure; and means for outputting the preferred upgrade plan of the set of upgrade plans based on updated performance parameters.

Aspect 16: The apparatus of any of the Aspects 13-15, in which the preferred network upgrade plan is a plan with a maximum total score.

Aspect 17: The apparatus of any of the Aspects 13-16, in which the maximum total score is based on values of the evaluation function over input traffic patterns.

Aspect 18: The apparatus of any of the Aspects 13-17, in which the set of upgrade plans comprises at least one of: an increased capacity of an existing link, a new link with a new capacity, and a new link with a shifted capacity.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted. Sets and subsets, in general, include one or more members.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communication protocols to facilitate communication between the different processors/processing elements. The processors can be configured for distributed processing and can utilize, in some aspects, a client-server model as needed. Accordingly, the methods, devices, and systems can utilize multiple processors and/or processor devices, and the processor/ processing element instructions can be divided amongst such single or multiple processor/devices/ processing elements.

The device(s) or computer systems that integrate with the processor(s)/ processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communication with other processors, where such one or more processor can be configured to operate on one or more processor/ processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communication protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific aspects thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the aspects disclosed herein, can include practices otherwise than specifically described, and are to be interpreted as broadly as allowed under the law.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
receiving a network topology describing a network;
receiving a set of traffic patterns for the network;
receiving a set of network upgrade plans for the network;
obtaining a set of performance parameters from a list of bottleneck structures based on the set of traffic patterns and the network topology, for each upgrade plan; and
selecting a preferred network upgrade plan from the set of network upgrade plans based on the performance parameters.

2. The processor-implemented method of claim 1, in which the selecting comprises applying an evaluation function to map the set of performance parameters to a score.

3. The processor-implemented method of claim 2, in which the selecting further comprises:
initializing the list of bottleneck structures;
for each traffic pattern in the list of traffic patterns, computing a bottleneck structure and adding the bottleneck structure to the list of bottleneck structures;
for each upgrade plan of the set of upgrade plans and each bottleneck structure in the list of bottleneck structures, applying the upgrade plan to each bottleneck structure to obtain a new bottleneck structure and updating the performance parameters according to the new bottleneck structure; and
outputting the preferred upgrade plan of the set of upgrade plans based on updated performance parameters.

4. The processor-implemented method of claim 3, in which the preferred network upgrade plan is a plan with a maximum total score.

5. The processor-implemented method of claim 4, in which the maximum total score is based on values of the evaluation function over input traffic patterns.

6. The processor-implemented method of claim 1, in which the set of upgrade plans comprises at least one of: an increased capacity of an existing link, a new link with a new capacity, and a new link with a shifted capacity.

7. An apparatus, comprising:
a memory; and
at least one processor coupled to the memory, the at least one processor configured:
to receive a network topology describing a network;
to receive a set of traffic patterns for the network;
to receive a set of network upgrade plans for the network;
to obtain a set of performance parameters from a list of bottleneck structures based on the set of traffic patterns and the network topology, for each upgrade plan; and
to select a preferred network upgrade plan from the set of network upgrade plans based on the performance parameters.

8. The apparatus of claim 7, in which the at least one processor is further configured to apply an evaluation function to map the set of performance parameters to a score.

9. The apparatus of claim 8, in which the at least one processor is further configured:
to initialize the list of bottleneck structures;
for each traffic pattern in the list of traffic patterns, to compute a bottleneck structure and add the bottleneck structure to the list of bottleneck structures;
for each upgrade plan of the set of upgrade plans and each bottleneck structure in the list of bottleneck structures, to apply the upgrade plan to each bottleneck structure to obtain a new bottleneck structure and update the performance parameters according to the new bottleneck structure; and
to output the preferred upgrade plan of the set of upgrade plans based on updated performance parameters.

10. The apparatus of claim 9, in which the preferred network upgrade plan is a plan with a maximum total score.

11. The apparatus of claim 10, in which the maximum total score is based on values of the evaluation function over input traffic patterns.

12. The apparatus of claim 7, in which the set of upgrade plans comprises at least one of: an increased capacity of an existing link, a new link with a new capacity, and a new link with a shifted capacity.

13. An apparatus, comprising:
means for receiving a network topology describing a network;
means for receiving a set of traffic patterns for the network;
means for receiving a set of network upgrade plans for the network;
means for obtaining a set of performance parameters from a list of bottleneck structures based on the set of traffic patterns and the network topology, for each upgrade plan; and
means for selecting a preferred network upgrade plan from the set of network upgrade plans based on the performance parameters.

14. The apparatus of claim 13, in which the means for selecting further comprises means for applying an evaluation function to map the set of performance parameters to a score.

15. The apparatus of claim 14, further comprising:
means for initializing the list of bottleneck structures;
for each traffic pattern in the list of traffic patterns, means for computing a bottleneck structure and adding the bottleneck structure to the list of bottleneck structures;
for each upgrade plan of the set of upgrade plans and each bottleneck structure in the list of bottleneck structures, means for applying the upgrade plan to each bottleneck structure to obtain a new bottleneck structure and updating the performance parameters according to the new bottleneck structure; and
means for outputting the preferred upgrade plan of the set of upgrade plans based on updated performance parameters.

16. The apparatus of claim 15, in which the preferred network upgrade plan is a plan with a maximum total score.

17. The apparatus of claim 16, in which the maximum total score is based on values of the evaluation function over input traffic patterns.

18. The apparatus of claim 13, in which the set of upgrade plans comprises at least one of: an increased capacity of an existing link, a new link with a new capacity, and a new link with a shifted capacity.
